(19) United States
(12) Patent Application Publication
(10) Pub. No.: US 2021/0389706 A1
(43) Pub. Date: Dec. 16, 2021

(54) FIXING DEVICE AND IMAGE FORMING APPARATUS

(71) Applicant: KYOCERA Document Solutions Inc., Osaka (JP)

(72) Inventors: Ryohei Tokunaga, Osaka (JP); Yuta Kitabayashi, Osaka (JP); Shunsaku Fujii, Osaka (JP)

(21) Appl. No.: 17/348,673

(22) Filed: Jun. 15, 2021

(30) Foreign Application Priority Data
Jun. 16, 2020 (JP) 2020-103531

(51) Int. Cl. G03G 15/20

(52) U.S. Cl. CPC G03G 15/2039; G03G 15/2053

(57) ABSTRACT

A sliding member is a tubular member surrounding a base member, and allows, by rotation, its lubricant-coated inner surface to slide in a sheet conveyance direction with respect to a surface of the base member. A heater heats the sliding member. A pressure roller forms a nip between the pressure roller and the sliding member and makes, by rotation, the sliding member rotate following the rotation. A temperature sensor measures a temperature of the base member or the sliding member. A roller driving device rotates the pressure roller at a preset initial speed and subsequently at a normal speed higher than the initial speed, in a temperature-rise process in which the temperature measured by the temperature sensor is raised to a target temperature by operation of the heater.

### INCORPORATION BY REFERENCE

This application is based upon and claims the benefit of priority from the corresponding Japanese Patent Application No. 2020-103531 filed on Jun. 16, 2020 the entire contents of which are incorporated herein by reference.

### BACKGROUND

The present disclosure relates to: a fixing device that fixes a toner image on a sheet; and an image forming apparatus provided with the fixing device.

An electrophotographic image forming apparatus is provided with a fixing device that heats and presses a toner image transferred on a sheet. Such a fixing device may be provided with: a heater having a plurality of heating elements arranged in a traverse direction; a tubular sliding member surrounding the heater; and a pressure roller that forms a nip through which sheets pass between the pressure roller and the sliding member.

When the pressure roller rotates, the sliding member rotates following the rotation thereof, allowing its inner surface to slide in a sheet conveyance direction with respect to the heater. The inner surface of the sliding member is coated with a lubricant.

The sliding member is subject to degradation due to abrasion, time-dependent deterioration of the lubricant, dust particles intruding on the inner surface of the sliding member, or the like. With the progress of degradation, the sliding member causes inconveniences such as an unusual noise or image degradation due to a skid of the pressure roller on the sliding member.

In relation to the fixing device, it is known that the life of the sliding member is estimated with reference to a difference between a starting torque and a driving torque of a motor that drives the pressure roller.

### SUMMARY

A fixing device according to one aspect of the present disclosure is a device that fixes a toner image onto a sheet by heating and pressing the toner image on the sheet at a fixing position of a sheet conveyance path. The fixing device is provided with a base member, a sliding member, a heater, a pressure roller, a temperature sensor, and a roller driving device. The base member is disposed at the fixing position in a traverse direction perpendicular to a sheet conveyance direction. The sliding member is a tubular member surrounding the base member; by rotation, the sliding member allows its lubricant-coated inner surface to slide in the sheet conveyance direction in contact with a surface of the base member. The heater heats the sliding member. The pressure roller forms a nip through which the sheet passes between the pressure roller and the sliding member, and makes, by rotation, the sliding member rotate following the rotation. The temperature sensor measures a temperature of the base member or the sliding member. The roller driving device rotates the pressure roller at a preset initial speed and subsequently at a normal speed higher than the initial speed, in a temperature-rise process in which a temperature measured by the temperature sensor is raised to a target temperature by operation of the heater.

An image forming apparatus according to another aspect of the present disclosure is provided with: a transfer device that transfers a toner image onto a sheet; and the fixing device that fixes the toner image onto the sheet.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a configuration of an image forming apparatus according to an embodiment.

FIG. 2 illustrates a configuration of a fixing device in the image forming apparatus according to the embodiment.

FIG. 3 is a block diagram illustrating a configuration of a control device in the image forming apparatus according to the embodiment.

FIG. 4 is a flowchart representing an example of a procedure for a fixing device start-up control by the image forming apparatus according to the embodiment.

### DETAILED DESCRIPTION

Hereinafter, one or more embodiments of the present disclosure will be described with reference to the drawings. Each embodiment to be described below is one example of the present disclosure and shall not be interpreted in any way to limit the technical scope of the present disclosure.

### Configuration of the Image Forming Apparatus 10

An image forming apparatus 10 according to an embodiment is an apparatus that performs a printing process, a process of forming an image on a sheet 9. The image forming apparatus 10 performs the printing process by electrophotography. The sheet 9 is an image formation medium such as a sheet of paper or a sheet-like resin member.

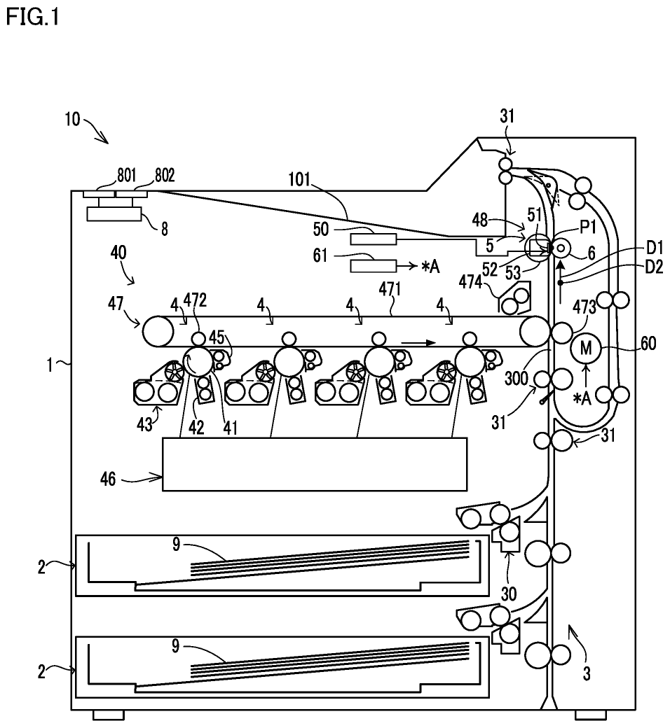

Referring to FIG. 1, the image forming apparatus 10 is provided with a sheet conveying device 3, a printing device 40, a control device 8, an operation device 801, and a display device 802; these devices are provided in a main body 1 of the image forming apparatus 10.

The operation device 801 is an interface that accepts user input, and includes operation buttons and a touch-screen panel, for example. The display device 802 is a device that displays information, and includes a flat-panel display device such as a liquid-crystal display unit.

The sheet conveying device 3 is provided with a sheet feed device 30 and multiple pairs of conveying rollers 31. The sheet feed device 30 sends the sheet 9, which is loaded in a sheet case 2, to a conveyance path 300 of the main body 1.

The multiple pairs of the conveying rollers 31 are rotationally driven by a motor (not shown). The conveying rollers 31 of each pair rotate and allow the sheet 9 to pass through between themselves, thereby convey the sheet S along the conveyance path 30. One of the multiple pairs of the conveying rollers 31 discharges the sheet 9 onto a discharge tray 101 through an outlet port of the conveyance path 300. Hereinafter, a direction in which the sheet 9 is conveyed along the conveyance path 300 will be referred to as a sheet conveyance direction D1. A direction along the conveyance path 300, intersecting the sheet conveyance direction D1 will be referred to as a traverse direction D2. In the present embodiment, the traverse direction D2 is a direction perpendicular to the sheet conveyance direction D1.

The printing device 40 forms a toner image on the sheet 9 conveyed along the conveyance path 300 by the sheet conveying device 3. The printing device 40 is provided with an imaging device 4, a laser scanning unit 46, a transfer device 47, and a fixing device 48. The imaging device 40 includes a drum-shaped photoconductor 41, a charging device 42, a developing device 43, a drum cleaning device 45, and the like.

The image forming apparatus 10 shown in FIG. 1 is a tandem color image forming apparatus. The printing device 40 is thus provided with four the imaging devices 4 corresponding to four toner colors: yellow, cyan, magenta, and black. The transfer device 47 is provided with: an intermediate transfer belt 471; four belt transfer devices 472 corresponding to the four imaging devices 4; a sheet transfer device 473; and a belt cleaning device 474.

In the imaging device 4, as the photoconductor 41 rotates, the charging device 42 electrically charges a surface of the photoconductor 41. Subsequently, the laser scanning unit 46 draws an electrostatic image on the surface of the photoconductor 41 by laser scanning. The photoconductor 41 is an example of an image carrier.

The developing device 43 then forms a toner image from the electrostatic image by supplying toner to the surface of the photoconductor 41.

The transfer device 47 transfers the toner image onto the sheet 9 on the conveyance path 300. In the transfer device 47, the belt transfer device 472 transfers the toner image, which is carried on the surface of the photoconductor 41, onto a surface of the intermediate transfer belt 471. The toner image is thereby formed in color on the surface of the intermediate transfer belt 471.

The sheet transfer device 473 transfers the toner image, which is carried on the intermediate transfer belt 471, onto the sheet 9 on the conveyance path 300.

When the image forming apparatus 10 is a monochrome image forming apparatus, the sheet transfer device 473 transfers the toner image, which is carried on the photoconductor 41, onto the sheet 9 on the conveyance path 300.

The drum cleaning device 45 removes toner remaining on the surface of the photoconductor 41. The belt cleaning device 474 removes toner remaining on the intermediate transfer belt 471.

The fixing device 48 fixes the toner image, which is carried on the sheet 9, onto the sheet 9 by applying heat and pressure at a fixing position P1 of the conveyance path 300.

The fixing device 48 is provided with a heating device 5, a pressure roller 6, a motor 60, and a motor driving circuit 61. The heating device 5 is provided with a heater 51, a supporting member 52, a sliding member 53, and a heater feeder circuit 50.

The sliding member 53 is a flexible, tubular member. In other words, the sliding member 53 is an endless, belt-like flexible tube. The sliding member 53 is a tubular film member, for example. The pressure roller 6 is a roller having an outermost layer made of an elastic material such as rubber.

The heater 51 is disposed at the fixing position P1 in the traverse direction D2. The heater 51 is constituted by a plurality of heating elements arranged in the traverse direction D2, for example. Each heating element produces heat by being supplied with power. The heater 51 heats the sliding member 53.

The supporting member 52 is a member supporting the heater 51. Similar to the heater 51, the supporting member 52 is disposed at the fixing position P1 in the traverse direction D2.

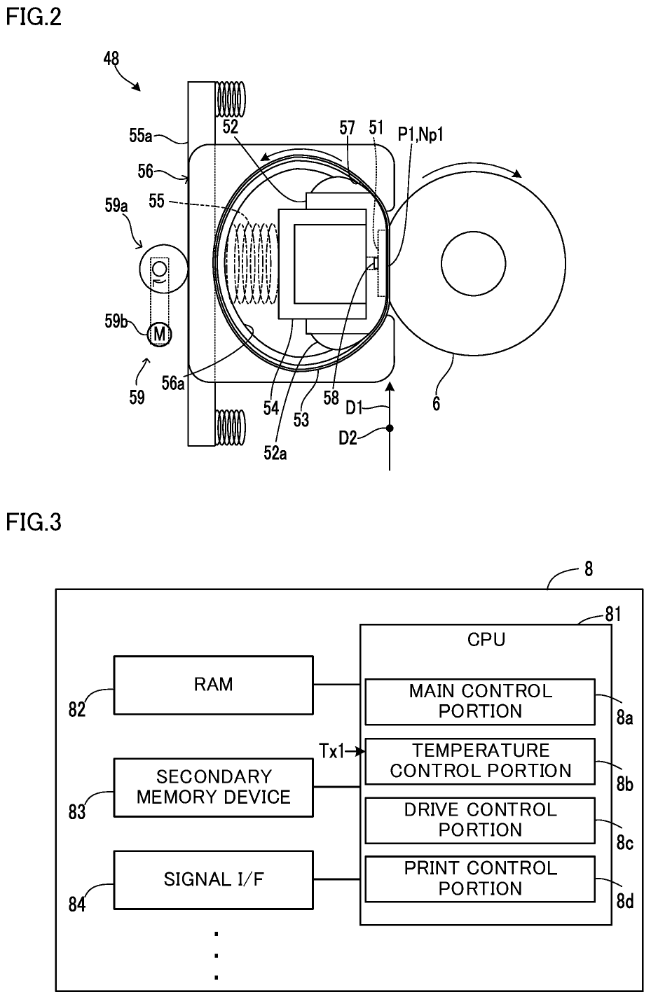

The sliding member 53 is supported such that it can rotate in a state of surrounding the heater 51 and the supporting member 52. Referring to FIG. 2, the fixing device 48 is further provided with a push member 54, a spring 55, and a pair of regulatory members 56.

The spring 55 elastically pushes the supporting member 52 via the push member 54 toward the pressure roller 6. Being elastically pushed by the spring 55, the push member 54 pushes the supporting member 52. The push member 54 further serves to reinforce the supporting member 52.

The regulatory members 56 are disposed at both ends of the sliding member 53 in the traverse direction D2. The pair of the regulatory members 56 keeps the sliding member 53 from deviation in the traverse direction D2. Each regulatory member 56 has a rim guiding portion 56a that internally protrudes from the end part of the sliding member 53 in the traverse direction D2.

The rim guiding portions 56a of the regulatory members 56 guide the circumferential orbits of the both end parts of the sliding member 53 in the traverse direction D2, along a predetermined curved path.

By being rotated around the heater 51 and the supporting member 52, the sliding member 53 allows its inner surface to slide in contact with the heater 51 and the supporting member 52 in the sheet conveyance direction D1.

The supporting member 52 has multiple ribs 52a that serve to reduce a frictional resistance with the sliding member 53. The ribs 52a are spaced in the traverse direction D2. Each rib 52a extends in a rotational direction of the sliding member 53. The inner surface of the sliding member 53 is coated with a lubricant 57.

In the present embodiment, the heater 51 is an example of a base member in contact with the inner surface of the sliding member 53. In other words, the heater 51 serves as a base member in contact with the inner surface of the sliding member 53, as well as a heating member that heats the sliding member 53.

The pressure roller 6 is supported such that it can rotate in a state of being, at the fixing position P1, in pressure contact with a part of the sliding member 53 which is along the heater 51. The pressure roller 6 forms a nip Np1 through which the sheet S passes between the pressure roller 6 and a part of the sliding member 53 which is along the heater 51. The position at which the nip Np1 is formed is the fixing position P1.

The motor 60 rotationally drives the pressure roller 6. The motor driving circuit 61 supplies, to the motor 60, power determined by a speed command from the control device 8. This allows the motor 60 to rotate at a speed determined by the speed command. The motor driving circuit 61 is an inverter driving circuit, for example.

By the pressure roller 6 rotating, the sliding member 53 is rotated with respect to the pressure roller 6. In other words, when the pressure roller 6 rotates, the sliding member 53 rotates following the rotation of the pressure roller 6.

The heater feeder circuit 50 supplies, to the heater 51, power determined by a heating command from the control device 8. When the power command indicates the extent of an increase or decrease of the amount of power supplied to the heater 51, for example, the heater feeder circuit 50 regulates the amount of the power supplied to the heater 51 in accordance with the power command.

The heating device 5 is further provided with a temperature sensor 58 that measures a temperature of the heater 51. The temperature measured by the temperature sensor 58 is used in a feedback control in which the temperature of the heater 51 is maintained at a preset target temperature Tx1 (see FIGS. 2 and 3). The temperature sensor 58 is a thermistor, for example.

The temperature sensor 58 measures a temperature of the fixing position P1, i.e., an alternative indicator of a temperature of the nip Np1. So, the temperature sensor 58 may be disposed at a position at which a temperature of the sliding member 53 can be measured.

### Pressure Regulatable Device 59

Referring to FIG. 2, the fixing device 48 is further provided with a pressure regulatable device 59 that is capable of regulating a fixing pressure, a pressure by which the supporting member 52 and the pressure roller 6 press the sliding member 53 between themselves.

The pressure regulatable device 59 is provided with, for example: a cam mechanism 59a that displaces a spring supporting portion 55a supporting an end part of the spring 55, which is opposite to the push member 54; and a cam driving device 59b that drives the cam mechanism 59a.

By being driven by the cam driving device 59b, the cam mechanism 59a displaces the spring supporting portion 55a in a direction in which the spring supporting portion 55a becomes closer to or more distant from the push member 54. The closer to the push member 54 the spring supporting portion 55a is, the greater the fixing pressure becomes; the more distant from the push member 54 the sprint supporting portion 55a is, the less the fixing pressure becomes.

By controlling the pressure regulatable device 59, a drive control portion 8c, for example, regulates the fixing pressure with reference to information of the thickness of the sheet 9, which is inputted in advance via the operation device 801. Specifically, when the thickness of the sheet 9 is great, the drive control portion 8c reduces the fixing pressure to less than the value to which the fixing pressure is adjusted when the thickness of the sheet 9 is small.

### Control Device 8

The control device 8 performs various data processes and controls devices such as the sheet conveying device 3, the printing device 40, and the display device 802.

Referring to FIG. 3, the control device 8 is provided with a central processing unit (CPU) 81, a random access memory (RAM) 82, and peripheral devices such as a secondary memory device 83 and a signal interface 84.

The CPU 81 is a processor that performs various data processes and exercises control by executing computer programs. The RAM 82 is a transitory computer-readable memory device. The RAM 82 records the computer programs to be executed by the CPU 81 and temporarily records data to be outputted and referred to by the CPU 81 while the CPU 81 executes various processes.

The CPU 81 includes a plurality of process modules to be enabled by executing the computer programs. The plurality of processing modules includes a main control portion 8a, a temperature control portion 8b, the drive control portion 8c, a print control portion 8d, and the like.

The main control portion 8a performs a start control for starting various processes as instructed via the operation device 801 and controls the display device 802.

The temperature control portion 8b regulates the amount of power supplied to the heating device 5 by a feedback control based on a comparison between the temperature measured by the temperature sensor 58 and the preset target temperature Tx1. The temperature control portion 8b regulates the amount of the power supplied to the heating device 5 by controlling the heater feeder circuit 50.

The drive control portion 8c controls the sheet conveying device 3. The print control portion 8d makes the printing device 40 perform the printing process in sync with the conveyance of the sheet 9.

The secondary memory device 83 is a non-transitory computer-readable memory device. The secondary memory device 83 is capable of recording and updating the computer programs and data in various forms. Either or both of a flash memory and a hard disk drive, for example, are employed as the secondary memory device 83.

The signal interface 84 converts signals outputted by various sensors such as the temperature sensor 58 into digital data form, then transfers the digital data to the CPU 81. The signal interface 84 further converts control commands outputted by the CPU 81 into control signals, then transfers the control signals to controlled devices.

When the fixing device 48 starts up under low temperature, a frictional load to the sliding member 53 is great because the lubricant 57 is high in viscosity under the condition. The motor 60 needs to have a relatively large rated power in order to rotate the pressure roller fast during start-up of the fixing device 48. The motor 60 thus consumes a considerable amount of power. Furthermore, a great frictional load to the sliding member 53 accelerates degradation of the sliding member 53.

In the present embodiment, the temperature control portion 8b and the drive control portion 8c perform a fixing device start-up control to be described later. The fixing device start- up control will reduce power consumed by the motor 60 and slow degradation of the sliding member 53.

Herein, the temperature control portion 8b and the drive control portion 8c, which perform the fixing device start-up control, constitute a part of the fixing device 48.

Hereinafter, the temperature measured by the temperature sensor 58 will be referred to as the measured temperature. The target temperature Tx1 is a preset temperature to be compared to the measured temperature after start-up of the fixing device 48.

### Fixing Device Start-up Control

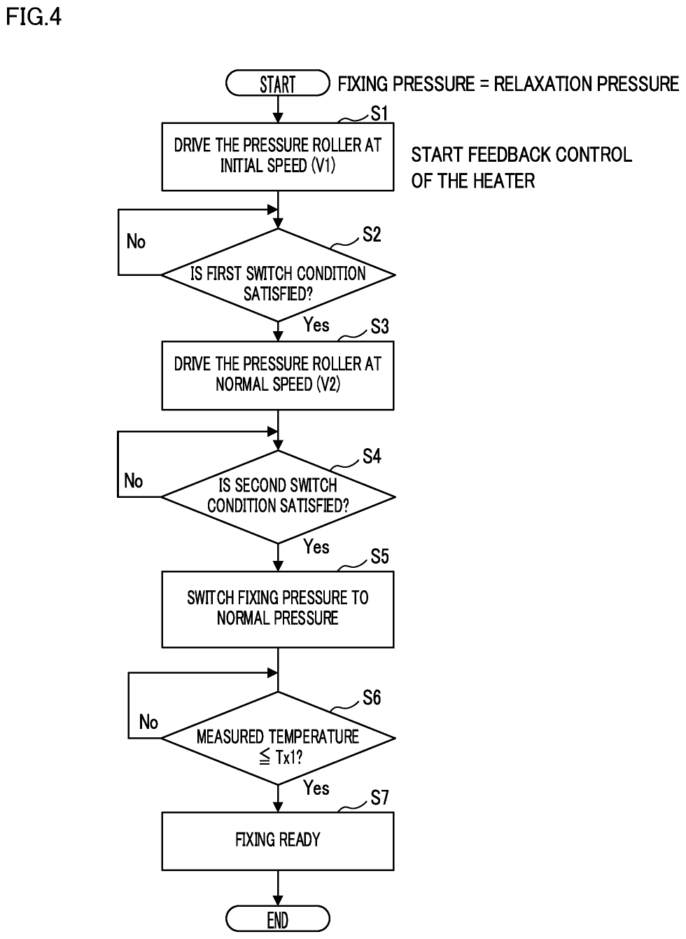

Hereinafter, an example of a procedure for the fixing device start-up control will be described with reference to a flowchart of FIG. 4.

The main control portion 8a starts the fixing device start-up control upon occurrence of a start-up event of the fixing device 48. The start-up event occurs when a job of the printing process is accepted by the print control portion 8d.

The signs S1, S2, . . . indicated in the following represent a plurality of steps in the fixing device start-up control. The heater 51 and the motor 61 are inactive before the fixing device start-up control is started.

Furthermore, before the fixing device start-up control is started, the pressure regulatable device 59 maintains the fixing pressure at a relaxation pressure that is less than a normal pressure that is applied when the sheet 9 passes through the nip Np1. This allows the pressure roller 6 to form the nip Np1 between the pressure roller 6 and the sliding member 53, with the relaxation pressure which is less than the normal pressure.

### Step S1

In the fixing device start-up control, the drive control portion 8c rotates the pressure roller 6 at a predetermined initial speed V1 by controlling the motor driving circuit 61. In other words, the motor 60 and the motor driving circuit 61 rotates the pressure roller 6 at the initial speed V1 in accordance with control commands from the drive control portion 8c. After that, the drive control portion 8c makes the process proceed to step S2.

The initial speed V1 is lower than a normal speed V2 that is a speed at which the pressure roller 6 rotates when the sheet 9 with the toner image formed thereon passes by the fixing device 48.

Furthermore, in Step S1, the temperature control portion 8b starts the feedback control of the heater 51. The feedback control serves to regulate the amount of the power supplied to the heater 51 with reference to a result of a comparison between the measured temperature and the target temperature Tx1.

### Step S2

In step S2, the drive control portion 8c judges whether or not a predetermined first switch condition is satisfied. The drive control portion 8c makes the process proceed to step S3 upon judging that the first switch condition is satisfied, and repeats the process in step S2 upon judging that it is not satisfied.

The first switch condition may include either or both of a first temperature change condition and a first elapsed time condition, for example. In the present embodiment, the first switch condition is a logical product of the first temperature change condition and the first elapsed time condition.

The first temperature change condition is a condition that the measured temperature has reached a predetermined first reference temperature that is lower than the target temperature Tx1. The first elapsed time condition is a condition that the period for which the pressure roller 6 continues rotating at the initial speed V1 has reached a predetermined first reference period. The first elapsed time condition referred to herein means the same as a condition that the number of revolutions of the pressure roller 6 rotating at the initial speed V1 has reached a predetermined number.

### Step S3

In step S3, the drive control portion 8c rotates the motor 60 at a normal speed that is higher than the initial speed V1, by controlling the motor driving circuit 61. In other words, the motor 60 and the motor driving circuit 61 rotates the pressure roller 6 at the normal speed V2 in accordance with control commands from the drive control portion 8c. After that, the drive control portion 8c makes the process proceed to step S4.

### Step S4

In step S4, the drive control portion 8c judges whether or not a predetermined second switch condition is satisfied. The drive control portion 8c makes the process proceed to step S5 upon judging that the second switch condition is satisfied, and repeats the process in step S4 upon judging that it is not satisfied.

The second switch condition may include either or both of a second temperature change condition and a second elapsed time condition, for example. In the present embodiment, the second switch condition is a logical product of the second temperature change condition and the second elapsed time condition.

The second temperature change condition is a condition that the measured temperature has reached a predetermined second reference temperature that is lower than the target temperature Tx1. The second reference temperature may be the same as or higher than the first reference temperature, for example.

The second elapsed time condition is a condition that the period for which the pressure roller 6 continues rotating at the normal speed V2 has reached a predetermined second reference period. The second elapsed time condition referred to herein means the same as a condition that the number of revolutions of the pressure roller 6 rotating at the normal speed V2 has reached a predetermined number.

### Step S5

In step S5, the drive control portion 8c switches the fixing pressure of the pressure regulatable device 59 from the relaxation pressure to the normal pressure by controlling the cam driving device 59b. In other words, the pressure regulatable device 59 switches the fixing pressure from the relaxation pressure to the normal pressure in accordance with control commands from the drive control portion 8c. After that, the drive control portion 8c makes the process proceed to step S6.

### Step S6

In step S6, the temperature control portion 8b keeps monitoring the measured temperature until the measured temperature reaches the target temperature Tx1. When the measured temperature reaches the target temperature Tx1, the temperature control portion 8b makes the process proceed to step S7.

### Step S7

In step S7, the temperature control portion 8b causes a fixing ready event to occur and terminates the fixing device start-up control. The fixing ready event indicates that a temperature of the fixing device 48 has been raised enough and is ready to fix the toner image onto the sheet 9. The occurrence of the fixing ready event means allowing conveyance of the sheet 9 to start.

After termination of the fixing device start-up control, the temperature control portion 8b continues the feedback control of the heater 51 until a stop event of the fixing device 48 occurs. Upon occurrence of the stop event, the temperature control portion 8b makes the heater feeder circuit 50 stop the power supplied to the heater 51.

Furthermore, upon occurrence of the stop event, the pressure regulatable device 59 switches the fixing pressure of the pressure regulatable device 59 itself from the normal pressure to the relaxation pressure in accordance with control commands from the drive control portion 8c.

Steps S1 to S7 of the fixing device start-up control correspond to a temperature-rise process in which the temperature measured by the temperature sensor 58 is raised to the target temperature Tx1 by operation of the heater 51.

In the temperature-rise process, the motor 60 and the motor driving circuit 61 rotate the pressure roller 6 at the preset initial speed V1 and subsequently at the normal speed V2 which is higher than the initial speed V1 (steps S1 to S3).

This will reduce a load to the motor 60 and a frictional load to the sliding member 53 when the lubricant 57 is low in temperature, namely, even when the lubricant 57 is high in viscosity. This will result in reduction of the power consumed by the motor 60 and a slow degradation of the sliding member 53.

In the present embodiment, the motor 60 and the motor driving circuit 61, which rotate the pressure roller 6 in steps S1 to S3, are an example of a roller driving device.

The roller driving device switches the rotation speed of the pressure roller 6 from the initial speed V1 to the normal speed V2 when either or both of the first temperature change condition and the first elapsed time condition are satisfied (steps S2 and S3).

The first temperature change condition is an example of a condition for confirming that the lubricant 57 is heated to an adequate viscosity. The first elapsed time condition is an example of a condition for confirming that the lubricant 57 distributed all over the inner surface of the sliding member 53 is heated to a sufficient degree by the heater 51.

Furthermore, in the temperature-rise process, the pressure regulatable device 59 switches the fixing pressure from the predetermined relaxation pressure to the normal pressure, which is greater than the relaxation pressure, in accordance with control commands from the drive control portion 8c (steps S4 and S5).

This will reduce the load to the motor 60 and the frictional load to the sliding member 53 when the lubricant 57 is low in temperature, namely, when the lubricant 57 is high in viscosity.

In the present embodiment, the relaxation pressure is an example of an initial pressure that is less than the normal pressure.

The pressure regulatable device 59 further switches the fixing pressure from the relaxation pressure to the normal pressure when either or both of the second temperature change condition and the second elapsed time condition are satisfied (steps S4 and S5).

In other words, the pressure regulatable device 59 switches the fixing pressure from the relaxation pressure to the normal pressure upon confirming that the lubricant 57 is heated to an adequate viscosity or the lubricant 57 distributed all over the inner surface of the sliding member 53 is heated to a sufficient degree.

### First Applied Example

Hereinafter, a first applied example of the fixing device 48 will be described.

In the present applied example, the heater 51 further heats a part of the sliding member 53, other than the part of the sliding member 53 in which the nip Np1 is formed. The heater 51 referred to herein may be an IH heater or the like.

Furthermore, in the present applied example, the inner surface of the sliding member 53 slides with respect to a part of the supporting member 52 that faces the fixing position P1. In the present applied example, the supporting member 52 is an example of a base member disposed at the fixing position P1 in the traverse direction D2.

When the present applied example is employed, the same effectiveness as when the fixing device 48 is employed will be brought.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A fixing device configured to fix a toner image onto a sheet by heating and pressing the toner image on the sheet at a fixing position of a sheet conveyance path, the fixing device comprising:
a base member disposed at the fixing position in a traverse direction perpendicular to a sheet conveyance direction;
a tubular sliding member surrounding the base member, the sliding member configured to allow, by rotation, a lubricant-coated inner surface of the sliding member to slide in the sheet conveyance direction with respect to a surface of the base member;
a heater configured to heat the sliding member;
a pressure roller configured to form a nip through which the sheet passes between the pressure roller and the sliding member and make, by rotation, the sliding member rotate following the rotation;
a temperature sensor configured to measure a temperature of the base member or the sliding member; and
a roller driving device configured to rotate the pressure roller at a preset initial speed and subsequently at a normal speed higher than the initial speed, in a temperature-rise process in which the temperature measured by the temperature sensor is raised to a target temperature by operation of the heater.

2. The fixing device according to claim 1, further comprising:
a pressure regulatable device configured to switch a fixing pressure from a predetermined initial pressure to a normal pressure greater than the initial pressure in the temperature-rise process, the fixing pressure being applied to the sliding member by the base member and the pressure roller.

3. The fixing device according to claim 2, wherein
the pressure regulatable device switches the fixing pressure from the initial pressure to the normal pressure upon satisfaction of either or both of: a temperature change condition that the temperature measured by the temperature sensor reaches a predetermined temperature lower than the target temperature; and an elapsed time condition that a period for which the pressure roller continues rotating at the initial speed reaches a predetermined period.

4. The fixing device according to claim 1, wherein
the roller driving device switches a rotation speed of the pressure roller from the initial speed to the normal speed upon satisfaction of either or both of: a temperature change condition that the temperature measured by the temperature sensor reaches a predetermined temperature lower than the target temperature; and an elapsed time condition that a period for which the pressure roller continues rotating at the initial speed reaches a predetermined period.

5. An image forming apparatus comprising:
a transfer device configured to transfer a toner image onto a sheet; and
the fixing device according to claim 1, configured to fix the toner image onto the sheet.
